(19) United States
(12) Patent Application Publication
(10) Pub. No.: US 2010/0036080 A1
(43) Pub. Date: Feb. 11, 2010

(54) PLASTICS MOULDINGS OF POLYURETHANE AND THEIR USE

(75) Inventors: Michael Merkel, Dusseldorf (DE); Norbert Eisen, Koln (DE); Lutz Liebegott, Leverkusen (DE); Günter Gansen, Neuss (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/535,188

(22) Filed: Aug. 4, 2009

(30) Foreign Application Priority Data
Aug. 7, 2008 (DE) 102008036995.0

(51) Int. Cl. C08G 18/32

(52) U.S. Cl. 528/65

(57) ABSTRACT

The invention relates to compact plastics mouldings having bulk densities of >1000 kg/m³, high strength, bending strength and high heat resistance, and to their use.

### RELATED APPLICATIONS

This application claims benefit to German Patent Application No. 10 2008 036 995.0, filed Aug. 7, 2008, which is incorporated herein by reference in its entirety for all useful purposes.

### BACKGROUND OF THE INVENTION

The invention relates to compact plastics mouldings having bulk densities of >1000 kg/m³, high strength, bending strength and high heat resistance, and to their use.

EP-A 1 671 993, U.S. Pat. No. 4,299,924 and EP-A 0 102 541 describe the production of polyurethane or polyisocyanate materials having high heat resistance, high strength and high bending strength. Polyol components containing filler (PHD polyols, PIPA polyols or SAN polyols) are used for this purpose. However, the high viscosity of the polyols used means that they are very poorly miscible with the isocyanates. In addition, the demands made in terms of machine technology are very high.

EP-A 0 922 063 describes polyurethane casting systems having high heat distortion resistance, which systems are formed by the reaction of polyisocyanates and polyols with a high index. Disadvantages here are the long demould time of up to one hour as well as the subsequent expensive and energy-intensive tempering process for several hours at temperatures of over 100° C.

WO 2004/111101 A1 describes polyurethane materials which have high strength, high heat resistance and high bending strength. The polyol component for producing such materials consists of from 80 to 100% polyether polyols which have an ethylene oxide content of more than 75 wt. % and an equivalent weight of from 150 to 1000.

WO 2007/042407 A1 discloses polyurethane elastomers which are produced using, as the main polyol component a polyol having a high ethylene oxide content and equivalent weights of from 1100 to 5000.

However, the impact strength of the elastomers of both the above-mentioned international applications is not particularly good, so that they are unsuitable for many applications, in particular in the commercial vehicle sector.

The object of the present invention was, while avoiding the use of fillers and reinforcing materials and the disadvantages associated therewith, to increase the impact strength while largely retaining the bending resistance and heat resistance and, despite long batch times, to produce rapidly curing mouldings which do not require tempering.

It was possible to achieve that object with the plastics mouldings according to the invention described in detail hereinbelow.

### EMBODIMENTS OF THE INVENTION

An embodiment of the present invention is a compact plastics moulding of at least one polyurethane having a bulk density of greater than 1000 kg/m³, as well as high strength, bending strength, and heat resistance, wherein said at least one polyurethane is obtained from
a) at least one organic polyisocyanate and/or at least one polyisocyanate prepolymer;
b) at least one polyol component;
c) at least one catalyst;
d) optionally at least one stabilizer; and
e) optionally at least one auxiliary substance and/or additive;

wherein said at least one polyol component b) is filler-free and comprises a mixture of from 21 to 70 weight % of a polyether polyol b1) having a functionality in the range of from 2 to 6, an equivalent weight in the range of from 210 to 2100, and from 10 to 74 weight % of ethylene oxide groups, based on the total weight of said polyol, wherein the content of primary hydroxyl groups is greater than 50%, and from 30 to 79 weight % of a polyol b2) other than b1) having an equivalent weight in the range of from 210 to 2100 and a functionality in the range of from 2 to 6.

Another embodiment of the present invention is the above compact plastics moulding, wherein the content of primary hydroxyl groups of said polyether polyol b1) is greater than 70%.

Another embodiment of the present invention is the above compact plastics moulding, wherein the isocyanate index is in the range of from 150 to 4000.

Another embodiment of the present invention is the above compact plastics moulding, wherein the isocyanate index is in the range of from 400 to 2000.

Another embodiment of the present invention is the above compact plastics moulding, wherein the isocyanate index is in the range of from 500 to 1000.

Another embodiment of the present invention is the above compact plastics moulding, wherein said at least one organic polyisocyanate a) comprises mixtures of isomeric diphenylmethane diisocyanates or mixtures of isomeric diphenylmethane diisocyanates and polyphenyl-polymethylene polyisocyanates.

Another embodiment of the present invention is the above compact plastics moulding, wherein the mean functionality of said mixtures of polyisocyanates is in the range of from 2 to 2.4.

Another embodiment of the present invention is the above compact plastics moulding, wherein said polyol component b2) comprises a polyether polyol having an ethylene oxide content of more than 75 weight %.

Yet another embodiment of the present invention is an automotive or commercial vehicle large-area part comprising the above compact plastics moulding.

### DESCRIPTION OF THE INVENTION

The present invention provides compact plastics mouldings of polyurethanes which have bulk densities of >1000 kg/m³ as well as high strength, bending strength and heat resistance, the polyurethane being obtainable from
a) organic polyisocyanates and/or polyisocyanate prepolymers
b) polyol components
c) at least one catalyst
d) optionally stabilisers
e) optionally auxiliary substances and additives,

characterised in that the filler-free polyol component b) contains a mixture of from 21 to 70 wt. % of a polyether polyol b1) having a functionality of from 2 to 6, an equivalent weight of from 210 to 2100 and from 10 to 74 wt. % ethylene oxide groups, based on the total weight of the polyol, the content of primary hydroxyl groups being greater than 50%, preferably greater than 70%, and from 30 to 79 wt. % of a polyol b2) other than b1) having an equivalent weight of from 210 to 2100 and a functionality of from 2 to 6.

The polyols b2) that are used are known per se to the person skilled in the art and are described in detail, for example, in G. Oertel “Kunststoffhandbuch”, Volume 7, Carl Hanser Verlag, 3rd Edition, Munich/Vienna 1993, pages 57 to 75. Polyether and polyester polyols are preferably used. The synthesis of the polyether chains can be carried out in known manner by alkoxylation of appropriate starter compounds, ethylene oxide and/or propylene oxide and/or butylene oxide preferably being used as alkoxylating agents. As starters there are preferably used hydroxyl- and/or amine-group-containing compounds having a starter functionality of from 2 to 6. Polyalcohols are preferably used as starters. For example, there come into consideration as starter compounds sorbitol, sucrose, pentaerythritol, glycerol, trimethylolpropane, propylene glycol, ethylene glycol, butylene glycol, ethylenediamine, toluylenediamine or water or mixtures thereof. The starter mixtures used likewise have a mean functionality of from 2 to 6. Polyether polyols having an ethylene oxide content of more than 75 wt. % are preferably used as the polyol b2).

The polyester polyols are prepared in a generally known manner by polycondensation of polyfunctional carboxylic acids with appropriate hydroxyl compounds, by polycondensation of hydroxycarboxylic acids, by polymerisation of cyclic esters (lactones), by polyaddition of carboxylic acid anhydrides to epoxides, or by esterification of acid chlorides with alkali salts of hydroxy compounds. The polyester polyols are preferably prepared by polycondensation of polyfunctional carboxylic acids, such as phthalic acid, isophthalic acid, terephthalic acid, fumaric acid, glutaric acid, adipic acid and succinic acid, with suitable hydroxyl compounds, such as ethylene glycol, diethylene glycol, tetraethylene glycol, 1,2-propanediol, 1,4-butanediol, 1,6-hexanediol, glycerol and trimethylolpropane.

As starting component a) there are used aliphatic, cycloaliphatic, araliphatic, aromatic and heterocyclic polyisocyanates as are described, for example, by W. Siefken in Justus Liebigs Annalen der Chemie, 562, pages 75 to 136, for example those of the formula

Q(NCO)ₙ

wherein
n denotes from 2 to 4, preferably from 2 to 2.4

and
Q denotes an aliphatic hydrocarbon radical having from 2 to 18 carbon atoms, preferably from 6 to 10 carbon atoms,
a cycloaliphatic hydrocarbon radical having from 4 to 15 carbon atoms, preferably from 5 to 10 carbon atoms,
an aromatic hydrocarbon radical having from 6 to 15 carbon atoms, preferably from 6 to 13 carbon atoms,
or an araliphatic hydrocarbon radical having from 8 to 15 carbon atoms, preferably from 8 to 13 carbon atoms.

Such polyisocyanates are described, for example, in DE-A 2 832 253, pages 10 to 11.

Particular preference is generally given to polyisocyanates that are readily available commercially, for example 2,4- and 2,6-toluylene diisocyanate and arbitrary mixtures of those isomers (“TDI”), polyphenyl-polymethylene polyisocyanates, as are prepared by aniline-formaldehyde condensation and subsequent phosgenation (“MDI”), and polyisocyanates containing carbodiimide groups, urethane groups, allophanate groups, isocyanurate groups, urea groups or biuret groups (“modified polyisocyanates”), in particular those modified polyisocyanates which are derived from 4,4′- and/or 2,4′-diphenylmethane diisocyanate. The content of the above-mentioned groups for modifying the polyisocyanate can be up to 30 wt. %, based on the polyisocyanate used. It is also possible to use mixtures of the above-mentioned polyisocyanates. There are preferably used as polyisocyanates mixtures of isomeric diphenylmethane diisocyanates or mixtures of isomeric diphenylmethane diisocyanates and polyphenyl-polymethylene polyisocyanates. These mixtures preferably have mean functionalities of from 2 to 2.4.

There come into consideration as catalysts c) any catalysts or catalyst systems known for the preparation of polyurethanes. Reference is made in this connection to “Kunststoffhandbuch” (ed. G. Oertel), Volume 7, Polyurethane, Carl Hanser Verlag, 3rd Edition, Munich/Vienna 1993, pages 104 ff. The alkali or ammonium carboxylates known per se, such as, for example, potassium acetate, potassium 2-ethylhexanoate, are preferably used. It is also possible to use a plurality of catalysts in combination.

As stabilisers d) there are preferably used modified polyether siloxanes, as are described in the above-mentioned “Kunststoffhandbuch”, Volume 7, pages 113 to 115.

Suitable auxiliary substances and additives e) are inhibitors, surfactants, emulsifiers, cell regulators, flameproofing agents, antioxidants, parting agents, colourings and light stabilisers. These are disclosed in “Kunststoffhandbuch”, Volume 7, pages 104 to 127.

The isocyanate index is from 150 to 4000, preferably from 400 to 2000, particularly preferably from 500 to 1000. The isocyanate index is the ratio of NCO groups to isocyanate-reactive hydrogen atoms multiplied by 100.

The parts according to the invention are produced in a mould. The mould is preferably closed. The mould has a temperature between room temperature and 150° C., preferably from 60 to 100° C. The reaction components are mixed at a temperature between room temperature and 80° C. and introduced into the mould. The parts are preferably produced by the known reaction-injection moulding technique (RIM process), as is described, for example, in DE-A 2 622 951 (U.S. Pat. No. 4,211,853) or DE-A 3 914 718, or by a casting process. Depending on the catalyst and the geometry of the moulding, the demould time is less than 10 minutes, preferably from 30 to 300 seconds. In order to improve the demould properties, the inside walls of the mould can be coated with known parting agents. Tempering of the parts at elevated temperatures is not necessary.

The plastics mouldings according to the invention are used, for example, for large-area parts in the automotive and commercial vehicle industry, in particular for parts that are exposed to heat.

The invention is to be explained in detail by means of the examples which follow.

All the references described above are incorporated by reference in their entireties for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

### EXAMPLES

Production Specification:

The starting components listed in Table 1 below were mixed in the appropriate amounts at a temperature of approximately 30° C. and introduced by means of the reaction-injection moulding technique into a closed, tempered metal mould which had been preheated to approximately 70° C. The sheets so produced, which had a thickness of 4 mm, were then demoulded after 90 seconds and investigated without being tempered further. The results of the investigation are to be found in Table 1.

TABLE 1

| | Example No. | | | | | | |
|---|---|---|---|---|---|---|---|
| | 1* | 2* | 3 | 4 | 5 | 6* | 7* |
| Polyether 1 [parts by weight] | 100.0 | | | | | | |
| Polyether 2 [parts by weight] | | 100.0 | 75.0 | 60.0 | 40.0 | | |
| Polyether 3 [parts by weight] | | | 25.0 | 40.0 | 60.0 | 100.0 | |
| SAN dispersion 1 [parts by weight] | | | | | | | 100.0 |
| Catalyst [parts by weight] | 0.4 | 0.4 | 0.4 | 0.4 | 0.4 | 0.4 | 0.7 |
| Isocyanate 1 [parts by weight] | 150.0 | 150.0 | 150.0 | 150.0 | 150.0 | 150.0 | 150.0 |
| Bulk density [kg/m³] | 1233 | 1233 | 1228 | 1235 | 1234 | 1231 | 1227 |
| Bending modulus according to | 2200 | 2013 | 1792 | 1608 | 1517 | 1501 | 1439 |
| DIN EN ISO 178 [N/mm²] | | | | | | | |
| Charpy impact strength according to | 61.9 | 65.3 | 82.3 | 78.2 | 72.4 | 46.6 | 12.1 |
| DIN EN ISO 179 [KJ/mm²] | | | | | | | |
| Proportion of test specimen not | 0% | 30% | 70% | 70% | 70% | 0% | 0% |
| broken | | | | | | | |
| HDT (heat deflection temperature) | 99 | 114 | 137 | 138 | 138 | 145 | 178 |
| according to DIN EN ISO 75-1/2 [° C.] | | | | | | | |

*Comparison examples: Examples 1 and 2 according to WO 2004/111101 A1; Example 6 according to WO 2007/042407 A1; Example 7 according to EP-A 1 671 993.
Polyether 1: Polyether having an OH number of 255 mg KOH/g, a functionality of 3, a propylene oxide content of 0.9 wt. %, an ethylene oxide content of 78.8 wt. %; prepared by alkoxylation of trimethylolpropane.
Polyether 2: Polyether having an OH number of 100 mg KOH/g, a functionality of 6, a propylene oxide content of 17.3 wt. %, an ethylene oxide content of 77.3 wt. %; prepared by alkoxylation of sorbitol.
Polyether 3: Polyether having an OH number of 37 mg KOH/g, a functionality of 3, a propylene oxide content of 26.8 wt. %, an ethylene oxide content of 71.2 wt. %, having 83% primary OH groups; prepared by alkoxylation of glycerol.
SAN dispersion 1: Styrene-acrylonitrile dispersion having an SAN content of 25 wt. % (acrylonitrile/styrene 25/75) in a trifunctional polyether having predominantly primary OH groups and an OH number of 27.
Catalyst: Potassium acetate, 25% in diethylene glycol.
Isocyanate 1: Carbodiimide/uretonimine-modified 4,4′-diphenylmethane diisocyanate having an NCO content of 29.5 wt. % and a carbodiimide/uretonimine content of 25 wt. %.

Surprisingly, the polyurethane mouldings according to the invention (Examples 3 to 5) exhibit a markedly increased Charpy impact strength. In conjunction with a bending strength (bending modulus) and heat distortion resistance (HDT) that are likewise high, the mouldings according to the invention are particularly suitable for use in large-area mouldings that are exposed to heat, which require a high strength.

1. A compact plastics moulding of at least one polyurethane having a bulk density of greater than 1000 kg/m³, as well as high strength, bending strength, and heat resistance, wherein said at least one polyurethane is obtained from
a) at least one organic polyisocyanate and/or at least one polyisocyanate prepolymer;
b) at least one polyol component;
c) at least one catalyst;
d) optionally at least one stabilizer; and
e) optionally at least one auxiliary substance and/or additive;
wherein said at least one polyol component b) is filler-free and comprises a mixture of from 21 to 70 weight % of a polyether polyol b1) having a functionality in the range of from 2 to 6, an equivalent weight in the range of from 210 to 2100, and from 10 to 74 weight % of ethylene oxide groups, based on the total weight of said polyol, wherein the content of primary hydroxyl groups is greater than 50%, and from 30 to 79 weight % of a polyol b2) other than b1) having an equivalent weight in the range of from 210 to 2100 and a functionality in the range of from 2 to 6.

2. The compact plastics moulding of claim 1, wherein the content of primary hydroxyl groups of said polyether polyol b1) is greater than 70%.

3. The compact plastics moulding of claim 1, wherein the isocyanate index is in the range of from 150 to 4000.

4. The compact plastics moulding of claim 1, wherein the isocyanate index is in the range of from 400 to 2000.

5. The compact plastics moulding of claim 1, wherein the isocyanate index is in the range of from 500 to 1000.

6. The compact plastics moulding of claim 1, wherein said at least one organic polyisocyanate a) comprises mixtures of isomeric diphenylmethane diisocyanates or mixtures of isomeric diphenylmethane diisocyanates and polyphenyl-polymethylene polyisocyanates.

7. The compact plastics moulding of claim 6, wherein the mean functionality of said mixtures of polyisocyanates is in the range of from 2 to 2.4.

8. The compact plastics moulding of claim 1, wherein said polyol component b2) comprises a polyether polyol having an ethylene oxide content of more than 75 weight %.

9. An automotive or commercial vehicle large-area part comprising the compact plastics moulding of claim 1.
